(19) United States
(12) Patent Application Publication
(10) Pub. No.: US 2005/0249348 A1
(43) Pub. Date: Nov. 10, 2005

(54) Data encryption/decryption method, device, and program

(76) Inventors: Hidetoshi Fujimoto, Toyokawa-city (JP); Masahiro Kimura, Kariya-city (JP)

Correspondence Address: POSZ LAW GROUP, PLC, 12040 SOUTH LAKES DRIVE, SUITE 101, RESTON, VA, 20191, US

(21) Appl. No.: 10/614,901

(22) Filed: Jul. 9, 2003

(30) Foreign Application Priority Data
Aug. 7, 2002 (JP) 2002-229949

(51) Int. Cl. H04K 1/00

(52) U.S. Cl. 380/28

(57) ABSTRACT

Encryption is executed with respect to an encryption target unit based on an encryption ratio with maintaining the same data length both prior to and subsequent to the encryption process. In Pattern 1, one third from the encryption target unit is encrypted, while two thirds (the rest) of the encryption target unit are not encrypted. In Pattern 2, three sub-patterns P1, P2, P3 that have different encryption ratios are applied. The sub-patterns P1, P2, P3 have the encryption ratios of 50%, 25%, and 75%, respectively. In Pattern 3, three sub-patterns P11, P12, P13 that have different encryption starting points in addition to the different encryption ratios are applied. The sub-patterns P11, P12, P13 encrypt based on encryption ratios of 50%, 25%, and 75% from 25%, 50%, and 0% subsequent to the beginning of the unit.

### CROSS REFERENCE TO RELATED APPLICATIONS

This application is based on and incorporates herein by reference Japanese Patent Application No. 2002-229949 filed on Aug. 7, 2002.

### FIELD OF THE INVENTION

The present invention relates to a technology of encryption or decryption, the technology enables reducing processing time in decryption along with restricting an illegal copy.

### BACKGROUND OF THE INVENTION

For instance, a map display device, a routing assistance device, or a navigation device executes certain process using map data. The map data used in the devices are stored in a storage media such as a DVD-ROM, a CD-ROM, or a HDD and supplied to users.

The map data are stored in an encrypted form prevents them from being illegally copied. However, encrypting all the map data leads to necessity of a large storing memory and a long processing time for decryption. This results in being impracticable. JP-A-2000-341266 describes a technology for a piece of data that requires protection and includes header information and content data. Here, the header information is encrypted by a complicated encrypting method whose decryption needs relatively long time, while the content data are encrypted by another encryption method whose decryption needs less time. JP-A-2001-517833 describes a technology where the content data are not encrypted while the header information or a volume descriptor is encrypted. Here, image or voice data are not encrypted so that high-speed processing in usage can be achieved.

However, in the case where the content data are not encrypted while the header information or the volume descriptor is encrypted, there is a possibility that the clear content data can be copied to be available in some manner. Although the copied data are not thoroughly functional due to the encrypted header information, contents of the content data can be clearly known.

In JP-A-2000-341266 mentioned above, all the data needing protection are encrypted although the applied encryption methods have different encryption intensities. The header information and content data are encrypted respectively by the encryption methods having different encryption intensities. Therefore, location of the header information and the content data within the encrypted data must be analyzed for preparation of the decryption. This involves an additional time for analyzing before the decryption.

### SUMMARY OF THE INVENTION

It is an object of the present invention to provide an encryption technology enables reduction of processing time in decryption along with restricting an illegal copy.

To achieve the above object, an encryption method for encryption target data is provided for the following. The encryption target data are divided into encryption target units. Each of the encryption target units is encrypted based on an encryption ratio of actually encrypted data length. Here, entire data length of the each of the encryption target units does not change both prior to and subsequent to being encrypted.

It is preferable that the encryption ratio includes a plurality of different kinds. It is preferable that encryption of the each of the encryption target units starts from an encryption starting point that is located in a certain point within the each of the encryption target units. It is furthermore preferable that the encryption starting point includes a plurality of different kinds, and a plurality of encryption patterns are generated by combination of the plurality of different kinds of the encryption ratio with the plurality of different kinds of the encryption starting point. Applying one or a combinational set of these structures to the encryption helps encryption intensity be reinforced.

### BRIEF DESCRIPTION OF THE DRAWINGS

The above and other objects, features, and advantages of the present invention will become more apparent from the following detailed description made with reference to the accompanying drawings. In the drawings:

FIGS. 1A and 1B are schematic block diagrams showing structures of a data encryption device and a data decryption device; and

FIGS. 2A to 2C are diagrams showing patterns for encryption.

### DETAILED DESCRIPTION OF THE PREFERRED EMBODIMENTS

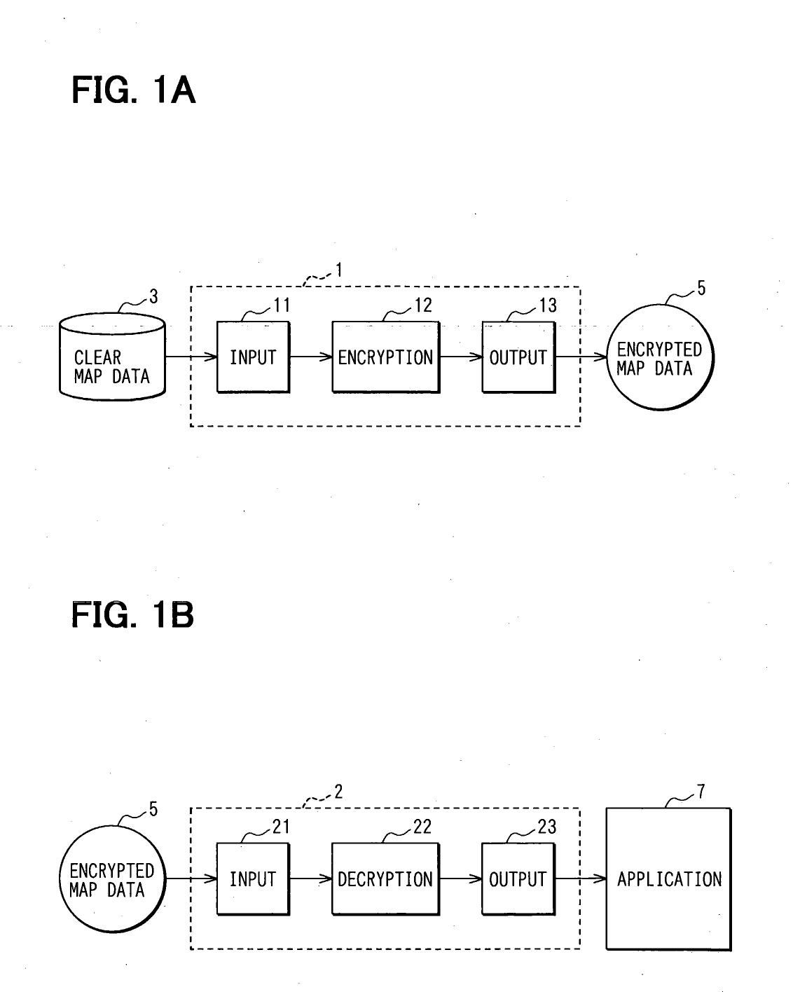

A data encryption device 1 and a data decryption device 2 as embodiments of the present invention are shown in FIGS. 1A, 1B. The data encryption device 1 includes an input module 11 for inputting data from an outside, an encryption module 12 for encrypting the inputted data, and an output module 13 for outputting the encrypted data. In this embodiment, clear map data stored in a data storage 3 are encrypted by the data encryption device 1 and then stored in a storage media 5 such as a DVD-ROM, a CD-ROM, or a HDD. The storage media 5 stored with the encrypted map data is distributed to users.

By contrast, the data decryption device 2 includes an input module 21 for inputting data from an outside, a decryption module 22 for decrypting the inputted data, and an output module 23 for outputting the decrypted data. In this embodiment, the encrypted map data stored in the storage media 5 are decrypted by the data decryption device 2 and then read by an application device 7 such as a car navigation. The application device 7 executes a predetermined process using the read map data. For instance, the car navigation executes map display or routing assistance.

The encryption module 12 or decryption module 22 is constructed as a known computer and includes components of a CPU, a ROM, a RAM, and input/output (I/O) terminals and a bus line electrically intermediating among the preceding components. Actual encryption or decryption is executed in the encryption module 12 or the decryption module 22, respectively. For encryption and decryption, keys corresponding to a signal book are necessary. There are a secret key (common key) encryption scheme using one key applied to both encryption and decryption and a public key encryption scheme using a pair of different keys, each of which is applied to encryption or decryption. The secret key encryption scheme includes DES (Data Encryption Standard) that is an encryption standard in the U.S. Government, IDEA, FEAL, MISTY, and the like. DES has not sufficient encryption intensity, so that TRIPLE DES that repeats processing of DES in three times is used. The secret key encryption scheme further includes AES (Advanced Encryption Standard) that is a next generation encryption standard in the U.S. Government. The public key encryption scheme includes RSA, Elgamal encryption, Elliptic Curve Cryptography, and the like.

Encryption process executed in the encryption module 12 of the data encryption device 1 will be explained below. In the process, a piece of data as an encryption target is divided into encryption target units, each of which has a certain data length. Each of the encryption target units is encrypted based on a predetermined encryption ratio of an actually encrypted portion within the encryption target unit to the entire encryption target unit. The certain data length is unvaried both prior to and subsequent to execution of the encryption.

Actual examples will be explained.

[Pattern 1]

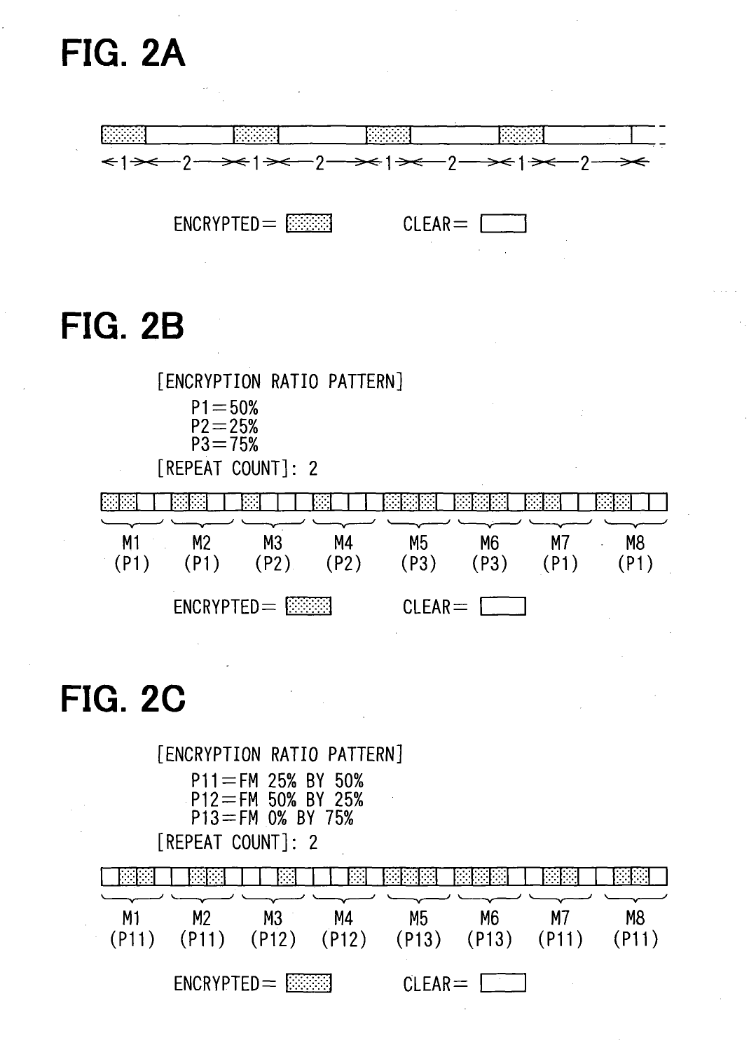

Pattern 1 is shown in FIG. 2A. Within an encryption target unit, an encryption ratio is 1/3. Namely, an encrypted portion is one third from the start of the encryption target unit, while an unencrypted (clear) portion is two thirds (the rest) of the encryption target unit. Each beginning one-third portion of the encryption target units is encrypted. The data length of the encryption target unit is unvaried both prior to and subsequent to execution of the encryption.

Here, if the encryption target unit is too long, an unencrypted portion of the encryption target unit may be recognizable and available for practical use when it is illegally copied. This results in reducing effectiveness of executing encryption. An upper limit of the length of the encryption target unit is set so that an unencrypted portion can be unrecognizable and unavailable for actual use when it is copied. In this embodiment, an encryption target is map data. The map data mainly include vector data, so that illegal copy may be ineffective as long as map data corresponding to a certain broad area do not remain unencrypted. The upper limit of the length can be set so that illegal copy can be ineffective for actual use. By contrast, a lower limit of the length of the encryption target unit can be set with consideration of processing load. The processing load increases with shortening encryption target unit. The lower limit of the length can be set based on necessary encryption intensity. For instance, the map data of this embodiment has an encryption target unit of approximately 2 kilobyte length.

[Pattern 2]

Pattern 2 is shown in FIG. 2B. It includes a plurality of sub-patterns and the sub-patterns are combined. For instance, an encryption target unit is set at data size S, and three sub-patterns P1, P2, P3 are prepared. An encryption target data length with respect to one sub-pattern is set at data size M (M=m×S).

In detail, data size S is 2 kilobytes and repeat count m of the same sub-pattern is two. Three sub-patterns are as follows:
P1—to encrypt by 50% from beginning of the encryption target unit S
P2—to encrypt by 25% from beginning of the encryption target unit S
P3—to encrypt by 75% from beginning of the encryption target unit S

As shown in FIG. 2B, P1, P2, and P3 are applied to the first and second encryption target units M1, M2, the third and fourth encryption target units M3, M4, and the fifth and sixth encryption target units M5, M6, respectively. Furthermore, P1 is also applied to the seventh and eighth encryption target units M7, M8, and similarly sub-patterns are repeatedly applied.

[Pattern 3]

Pattern 3 is shown in FIG. 2C. In this pattern, an encryption target unit is not always encrypted from the beginning. Starting point of encryption is varied from the beginning to another. For instance, an encryption target unit is set at data size S, and three sub-patterns P11, P12, P13 are prepared. An encryption target data length with respect to one sub-pattern is set at data size M (M=m×S). Each sub-patterns has each starting point of encryption.

In detail, data size S is 2 kilobytes and repeat count m of the same sub-pattern is two. Three sub-patterns are as follows:
P11—to encrypt by 50% from 25% point subsequent to beginning of the encryption target unit S
P12—to encrypt by 25% from 50% point subsequent to beginning of the encryption target unit S
P13—to encrypt by 75% from beginning (=0% subsequent to beginning) of the encryption target unit S

As shown in FIG. 2C, P11, P12, and P13 are applied to the first and second encryption target units M1, M2, the third and fourth encryption target units M3, M4, and the fifth and sixth encryption target units M5, M6, respectively. Furthermore, P11 is also applied to the seventh and eighth encryption target units M7, M8, and similarly sub-patterns are repeatedly applied.

The map data encrypted as above in the encryption module 12 of the data encryption device 1 are decrypted in the decryption module 22 of the data decryption device 2. The data decryption device 2 stores the above-mentioned each encryption pattern and its encryption key to decrypt.

For instance, for the map data encrypted by Pattern 1 shown in FIG. 2A, the decryption device 22 decrypts, using the encryption key, only one-third length of the respective encryption target units along with passing the rest two-third length that are not decrypted.

For instance, for the first and second encryption target units M1, M2 of the map data encrypted by Pattern 3 shown in FIG. 2C, the decryption device 22 decrypts as follows. Namely, a 25% portion of 0 to 25% subsequent to the beginning is not decrypted, a 50% portion of 25 to 75% subsequent to the beginning is decrypted, and a 25% portion of 75 to 100% subsequent to the beginning is not decrypted. For the third and fourth encryption target units M3, M4, a 50% portion of 0 to 50% subsequent to the beginning is not decrypted, a 25% portion of 50 to 75% subsequent to the beginning is decrypted, and a 25% portion of 75 to 100% subsequent to the beginning is not decrypted. For the fifth and sixth encryption target units M5, M6, a 75% portion of 0 to 75% subsequent to the beginning is decrypted, and a 25% portion of 75 to 100% subsequent to the beginning is not decrypted.

As explained above, in the encryption process of the embodiment, a piece of data as an encryption target is divided into encryption target units, each of which is encrypted based on a predetermined encryption ratio without changing a data length prior to and subsequent to the encryption process.

It is conventionally supposed that content data are not encrypted while header information is encrypted. However, there is a possibility that the clear content data can be copied with remaining available. Although the copied data are not thoroughly functional due to the encrypted header information, contents of the content data can be clearly known. This situation can be hardly acceptable. Furthermore, it is conventionally supposed that encryption is executed based on data attributes such as header information and content data. This case involves, before decryption, analysis and determination of the data attributes that need an additional processing load.

By contrast, in the embodiment, although an unencrypted portion of an encryption target unit remains, the rest of the encryption target unit is encrypted. Since all of the encryption target unit cannot be recognizable, the unencrypted portion cannot be available. Furthermore, in this embodiment, encryption is executed based on an encryption ratio and an encryption target unit. The encryption or decryption can be thereby automatically executed based on a predetermined rule, without analyzing where the header information or the data contents are located in a stream of the data. This leads to reduction of processing load in the encryption or decryption processing. Furthermore, since the data length is the same prior to and subsequent to the encryption process, the data decryption device 2 needs to know only an encryption rule and key to decrypt.

(Modification)

In the above embodiment, although an encryption target is map data for a car navigation or the like, it is not limited to the map data. Vector data are mainly assumed in the map data, but image data, voice data, or text data can be also the encryption target.

In the embodiment shown in FIG. 2C, a pattern includes three encryption ratios of 25%, 50%, and 75%, and three encryption starting points of 0%, 25%, and 50% subsequent to the head. Although three sub-patterns are generated by combining the three encryption ratios with the three encryption starting points, nine sub-patterns can be also generated. For instance, with the same encryption ratio of 50%, three different sub-patterns having encryption starting points of 0%, 25%, and 50% subsequent to the head can be generated. The encryption intensity increases with increasing encryption pattern number.

The encryption or the decryption process can be handled as a program that can be stored in a storage media, where a computer can read data, such as a flexible disk, a magnetic optical disk, a CD-ROM, a HDD, a ROM, a RAM, or the like. The program can be thereby loaded and activated as needed in the computer. Furthermore, the program can be loaded via a communications network.

It will be obvious to those skilled in the art that various changes may be made in the above-described embodiments of the present invention. However, the scope of the present invention should be determined by the following claims.

1. An encryption method for encryption target data, comprising steps of:
dividing the encryption target data into encryption target units; and
encrypting each of the encryption target units based on an encryption ratio of actually encrypted data length, within the each of the encryption target units, to entire data length of the each of the encryption target units,
wherein the entire data length of the each of the encryption target units does not change both prior to and subsequent to being encrypted.

2. The encryption method according to claim 1,
wherein the encryption ratio includes a plurality of different kinds, and
wherein each of the plurality of different kinds of the encryption ratio is applied, in certain order, for encrypting.

3. The encryption method according to claim 2,
wherein, when a certain kind of the encryption ratio is applied in the certain order, the certain kind of the encryption ratio is repeatedly applied for encrypting, at a certain number of times.

4. The encryption method according to claim 1,
wherein, when the each of the encryption target units is encrypted based on the encryption ratio, encryption of the each of the encryption target units starts from an encryption starting point that is located in a certain point within the each of the encryption target units.

5. The encryption method according to claim 4,
wherein the encryption starting point includes a plurality of different kinds,
wherein a plurality of encryption patterns are generated by combination of the plurality of different kinds of the encryption ratio with the plurality of different kinds of the encryption starting point, and
wherein each of the plurality of encryption patterns is applied, in given order, for encrypting.

6. A data encryption device for encrypting encryption target data, comprising:
an inputting module for inputting the encryption target data;
an encrypting module for encrypting the inputted encryption target data; and
an outputting module for outputting the encrypted encryption target data,
wherein the encrypting module includes:
dividing means for dividing the inputted encryption target data into encryption target units; and
encrypting means for encrypting each of the encryption target units based on an encryption ratio of actually encrypted data length, within the each of the encryption target units, to entire data length of the each of the encryption target units, wherein the entire data length of the each of the encryption target units does not change both prior to and subsequent to being encrypted.

7. A data encryption program executed in a computer for encrypting encryption target data, comprising steps of:
inputting the encryption target data to the computer;
encrypting the inputted encryption target data; and
outputting the encrypted encryption target data,
wherein the encrypting step includes steps of:
dividing the inputted encryption target data into encryption target units; and
encrypting each of the encryption target units based on an encryption ratio of actually encrypted data length, within the each of the encryption target units, to entire data length of the each of the encryption target units, wherein the entire data length of the each of the encryption target units does not change both prior to and subsequent to being encrypted.

8. A decryption method for decrypting decryption target data based on an encryption rule that is applied to encryption of encryption target data for producing the decryption target data, comprising steps of:
dividing the decryption target data into decryption target units; and
decrypting each of the decryption target units based on a decryption ratio of actually decrypted data length, within the each of the decryption target units, to entire data length of the each of the decryption target units,
wherein the entire data length of the each of the decryption target units does not change both prior to and subsequent to being decrypted.

9. The decryption method according to claim 8,
wherein the decryption ratio includes a plurality of different kinds, and
wherein each of the plurality of different kinds of the decryption ratio is applied, in certain order, for decrypting.

10. The decryption method according to claim 9,
wherein, when a certain kind of the decryption ratio is applied in the certain order, the certain kind of the decryption ratio is repeatedly applied for decrypting, at a certain number of times.

11. The decryption method according to claim 8,
wherein, when the each of the decryption target units is decrypted based on the decryption ratio, decryption of the each of the decryption target units starts from a decryption starting point that is located in a certain point within the each of the decryption target units.

12. The decryption method according to claim 11,
wherein the decryption starting point includes a plurality of different kinds,
wherein a plurality of decryption patterns are generated by combination of the plurality of different kinds of the decryption ratio with the plurality of different kinds of the decryption starting point, and
wherein each of the plurality of decryption patterns is applied, in given order, for decrypting.

13. A data decryption device for decrypting decryption target data based on an encryption rule that is applied to encryption of encryption target data for producing the decryption target data, comprising:
an inputting module for inputting the decryption target data;
a decrypting module for decrypting the inputted decryption target data; and
an outputting module for outputting the decrypted decryption target data,
wherein the decrypting module includes:
dividing means for dividing the decryption target data into decryption target units; and
decrypting means for decrypting each of the decryption target units based on a decryption ratio of actually decrypted data length, within the each of the decryption target units, to entire data length of the each of the decryption target units, wherein the entire data length of the each of the decryption target units does not change both prior to and subsequent to being decrypted.

14. A data decryption program executed in a computer for decrypting decryption target data based on an encryption rule that is applied to encryption of encryption target data for producing the decryption target data, comprising steps of:
inputting the decryption target data to the computer;
decrypting the inputted decryption target data; and
outputting the decrypted decryption target data,
wherein the decrypting step includes steps of:
dividing the inputted decryption target data into decryption target units; and
decrypting each of the decryption target units based on a decryption ratio of actually decrypted data length, within the each of the decryption target units, to entire data length of the each of the decryption target units, wherein the entire data length of the each of the decryption target units does not change both prior to and subsequent to being decrypted.
